(19) United States
(12) Patent Application Publication
(10) Pub. No.: US 2015/0266043 A1
(43) Pub. Date: Sep. 24, 2015

(54) SUPPLY CONTAINER AND FLUID SUPPLY ASSEMBLY

(71) Applicant: CANAMERICA, LLC, BROOKLINE, MA (US)

(72) Inventor: CHUN CHIN LIU, BROOKLINE, MA (US)

(73) Assignee: CHUN CHIN LIU, BROOKLINE, MA (US)

(21) Appl. No.: 14/322,944

(22) Filed: Jul. 3, 2014

(30) Foreign Application Priority Data
Mar. 21, 2014 (TW) 103110658

(51) Int. Cl. B05B 11/00

(52) U.S. Cl. CPC B05B 11/3085; B05B 11/0037; B05B 11/0089

(57) ABSTRACT

A fluid supply assembly includes a holding member and a plurality of output heads. The holding member has an assembling surface, an outer surface opposing to the assembling surface and a plurality of through holes. The through holes extend from the assembling surface to the outer surface respectively. The output heads are fixed at the through holes, each protrudes from the assembling surface. Each output head has an output opening The output heads respectively cover the through holes. A fluid flows from one of the output openings after passing through one of the through holes.

### BACKGROUND OF THE INVENTION

1. Field of the Invention

The instant disclosure relates to a fluid retaining container and elements of the container; in particular, to a supply container and a fluid supply assembly.

2. Description of Related Art

More than half of the cleaning and care products currently sold in the market such as shampoo, conditioner, shower gel, and lotion, are all individually packaged in separate containers. For example, shampoo is typically retained in a dispenser pump bottle, while shower gel is retained in another. Users, specifically female users, possess at least one or more bottle of shampoo, shower gel, conditioner and lotion for hygienic purposes.

Since cleaning and care products are individually packaged in different containers, various cans and bottles of cleaning and care products often occupy large amount of space in places such as a bathroom. In tight spaces, the presence of multiple cans and bottles of cleaning and care products can be a nuisance to the users.

To address the issues introduced, the inventor, having associated experience and research, presents the instant disclosure, which can effectively improve the limitation described.

### SUMMARY OF THE INVENTION

The objective of the instant disclosure is to provide a supply container having at least two chambers for fluid retention.

The instant disclosure provides a fluid supply assembly having at least two output heads for fluids to flow therefrom.

The instant disclosure provides a fluid supply assembly including a holding member and a plurality of output heads. The holding member has an assembling surface, an outer surface opposite to the assembling surface and a plurality of through holes. The through holes extend from the assembling surface to the opposite outer surface. Each output head is respectively fixed on one of the through holes, the output heads protrude from the assembling surface, and each output head has an output opening Each of the output heads respectively covers one of the through holes, and a fluid passes through one of the through holes and successively through one of the output openings.

The instant disclosure provides a supply container including a container body, a divider, and the aforementioned fluid supply assembly. The divider is arranged in the container body to form a plurality of chambers therein. The fluid supply assembly is an embodiment that accompanies the container body. The holding member is arranged between the output heads and the container body, and each output opening is in fluid communication with one of the chambers via the respective through hole in a one-to-one configuration.

In summary, the chambers can accommodate at least two types of fluids (such as cleaning products and care products) depending on the number of chambers provided, and one fluid can be drawn from one of the output openings through one through hole, such that different kinds of fluids are isolated yet retained within a single supply container. Compared to the existing individually packed bottles or cans of cleaning products and care products, the instant disclosure provides a single supply container that can be filled with multiple cleaning products or care products therein to reduce the spaced occupied, which is preferably used in small and tight spaces.

In order to further understand the instant disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1A is a perspective view of a supply container in accordance with a first embodiment of the instant disclosure;

FIG. 1B is an exploded view of the supply container in FIG. 1A;

FIG. 1C is a perspective view of a fluid supply assembly in FIG. 1B;

FIG. 1D is a top view of the fluid supply assembly in FIG. 1C;

FIG. 2 is a perspective view of the fluid supply assembly in accordance with another embodiment of the instant disclosure;

FIG. 3 is a perspective view of the fluid supply assembly in accordance with another embodiment of the instant disclosure; and

FIG. 4 a perspective view of the fluid supply assembly in accordance with another embodiment of the instant disclosure.

### DETAILED DESCRIPTION OF THE PREFERRED EMBODIMENTS

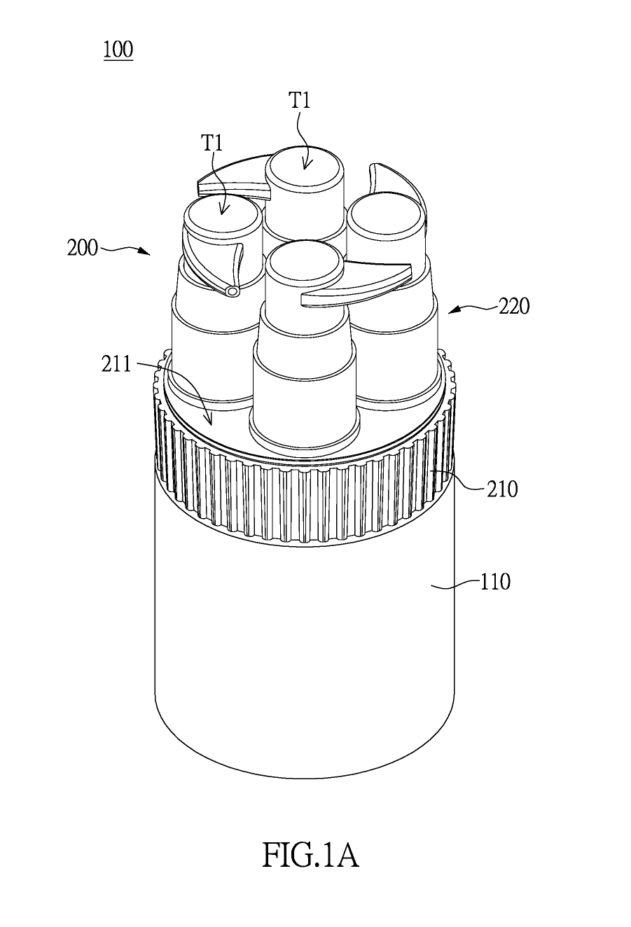

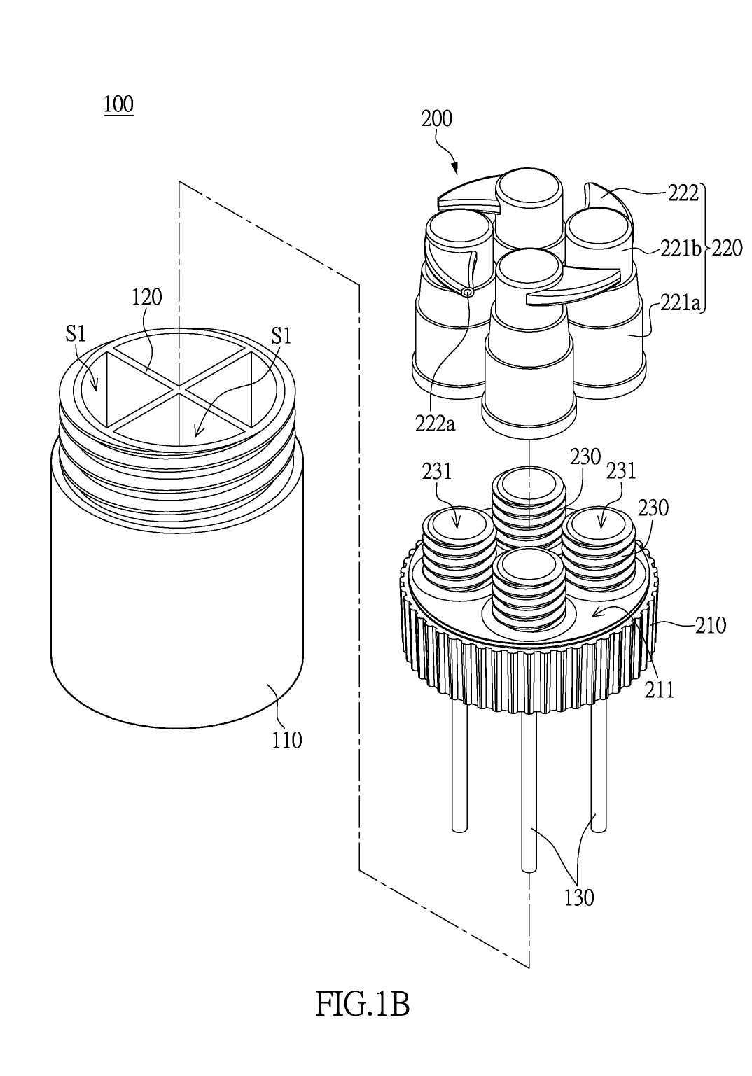

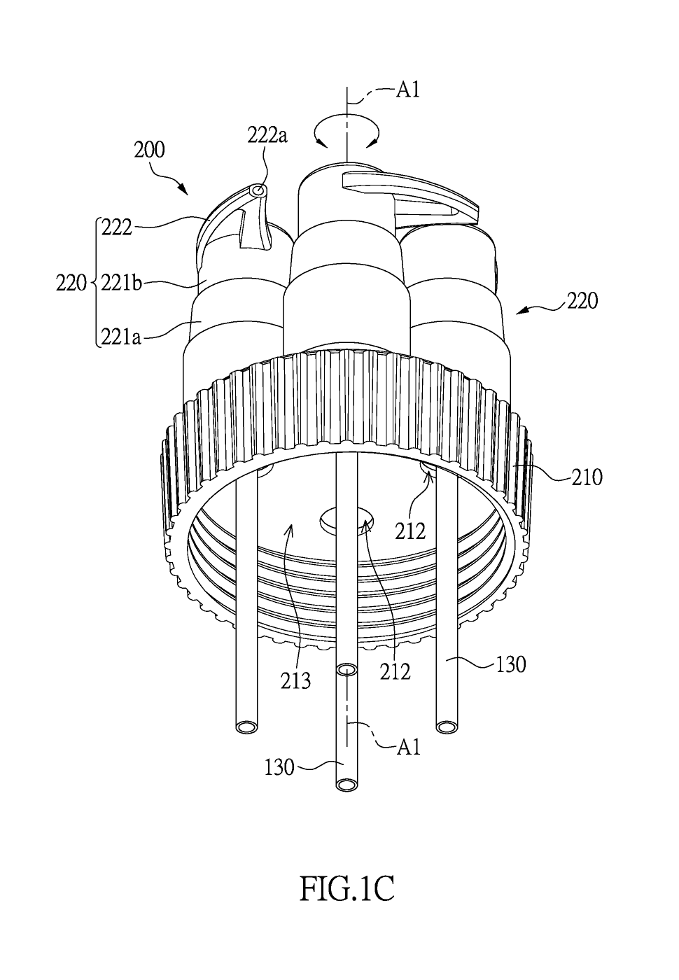

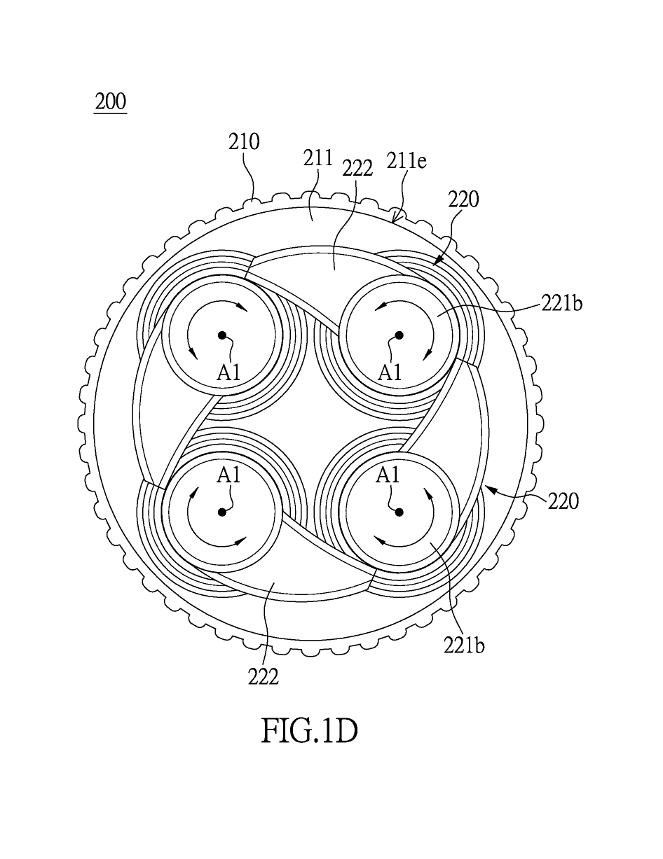

FIG 1A is a perspective view of a supply container in accordance with a first embodiment of the instant disclosure, whereas FIG. 1B is an exploded view of the supply container in FIG. 1A. In FIGS. 1A and 1B, a supply container 100 includes a container body 110, a divider 120 and a fluid supply assembly 200. The divider 120 is arranged in the container body 110 and compartmentalized the container body 110 into a plurality of chambers S1. As shown in FIG. 1B, the divider 120 can be made of a plurality of dividers. One side of each of the four dividers are coupled to the other three sides of the respective three dividers such that the cross-section of the divider 120 resembles the shape of a cross and forms four chambers S1 in the container body 110.

The chambers S1 can retain at least two different kind of fluids (not shown), in which the fluids can be a liquid or a Bingham fluid (or Bingham plastic). Moreover, fluids can be cleaning products, cosmetics or food related products. Each chamber S1 can contain a fluid such as shampoo, shower gel, face wash gel or even dish washing gel and cleaning detergent. In another example, the chamber S1 can also retain lotions or conditioners cosmetics or care products. In terms of food products, the chamber S1 can retain honey, maple syrup, ketchup, vinegar, sesame oil, soy sauce, or any similar fluid type of food products. The chamber S1, in general, can retain at least two various cleaning products, care or cosmetic products, or food products.

The fluid supply assembly 200 can be assembled with the container body 110. The fluid supply assembly 200 and the container body 110 can be assembled through various ways, such as transitional fit, locking, or screwing. A user can obtain a single fluid (shampoo, gel or maple syrup) by simply withdrawing from a single chamber S1 of the fluid supply assembly 200. In other possible embodiments, the fluid supply assembly 200 is also compatible to be assembled with other independent containers that retain various kinds of fluids therein via transitional fit, locking or screwing.

The fluid supply assembly 200 includes a holding member 210, a plurality of output heads 220 and a plurality of threaded tubes 230. The holding member 210 has an assembling surface 211. The threaded tubes 230 are coupled to the holding member 210 and are fixed on the assembling surface 211. The assembling surface 211 can be a flat surface in the instant embodiment, and the threaded tubes 230 are located on the assembling surface 211 of the holding member 210. Each threaded tube 230 has a tube opening 231. The threaded tube 230 protrudes from the assembling surface 211. Each output head 220 is secured to one of the threaded tubes 230 by screwing, so that the output heads 220 can be fixed on the assembling surface 211. The holding member 210 is arranged between the output heads 220 and the container body 110.

FIG. 1C is a perspective view of a fluid supply assembly in FIG. 1B. Refer to FIGS. 1B and 1C. The holding member 210 further includes a plurality of through holes 212 and an outer surface 213 corresponding to the assembly surface 211. The through holes 212 extend from the assembling surface 211 to the outer surface 213. Each through hole 212 is in air communication with one of the tube openings 231. In the embodiment as shown in FIG. 1B, the tube openings 231 and the through holes 212 can extend in the same general direction. Each tube opening 231 and the through hole 212 thereunder can be coaxial as shown in FIGS. 1B and 1C. When each output head 220 is secured with one of the threaded tubes 230 via screwing, each output head 220 is fixed to one of the through holes 212, and the output heads 220 respectively cover the through holes 212.

Notably, in other embodiments, the output heads 220 can be fixed on the assembling surface 211 in other manners besides the threaded tubes 230. For example: One end of an output head 220 can have screw threads integrally formed on side surfaces of the output head 220 while inner walls of a through hole 212 can be integrally formed with corresponding screw threads matching that on the side surfaces of the output head 220. Moreover, the output head 220 can also be screwed into the through holes 212 in order to fix the output heads 220 on the assembling surface 211. The output heads 220 are not limited to be fixed solemnly on the threaded tubes 230 of the assembling surface 211.

In the instant embodiment, output heads 220 are dispenser pump heads or pump dispensers that pump fluids from the chambers S1. Specifically, each output head 220 has an output opening 222a. Each output opening 222a is in fluid communication with one through hole 212 and one chamber S1 in a one-to-one configuration. When one output head 220 draws fluid from the corresponding chamber S1, the fluid flows pass the through hole 212 and flows through the output opening 222a of the output head 220.

Additionally, the supply container 100 includes a plurality of tubes 130. Each tube 130 is individually coupled to an output head 220 and is in fluid communication with one of the output openings 222a. Each tube 130 passes through a through hole 212 and is arranged in a chamber S1 in a one-to-one configuration. For example: When a user places pressure on an output head 220, the fluid within the corresponding chamber S1 of the output head 220 is dispensed into the tube 130 due to pressure difference, flows pass the through hole 212 directly to the corresponding output opening 222a of the output head 220 that was pressed upon.

In the embodiment shown in FIGS. 1A and 1B, the fluid supply assembly 200 can be securely coupled to the container body 110 via screwing. Specifically, after the preferred fluids are retained in the respective chambers S1 of the container body 110, the holding member 210 and the container body 110 are assembled together via screwing. Successively, the tubes 130 are coupled to the output heads 220. Each output head 220 connected to one tube 130 is then coupled to one of the threaded tubes 230 via screwing and the tube 130 is inserted into one of the tube openings 231 and one of the through holes 212 (as shown in FIG. 1C), which basically completes the assembly of the supply container 100.

Refer to FIG. 1A, top ends T1 of the output heads 220 are color coded and may be adjusted according to users' preference. To elaborate, a top end T1 of an output head 220 may have a certain color that differentiates from a top end T1 of another output head 220. In another example, the entire body of each output head 220 may have a different color from another output head 220. The color coding solely on the top ends T1 or over the entire body of output heads 220 can assist users in correctly identify and withdraw the desired fluid(s), thus, reducing the chances of selecting the wrong output heads 220.

Refer to FIGS. 1B and 1C. Each output head 220 includes a fixing member 221a, a rotatable member 221b, and an output member 222. The fixing member 221a can be coupled to the threaded tube 230 via screwing. The output member 222 has an output opening 222a and is coupled to the rotatable member 221b. As shown in FIGS. 1B and 1C, the output member 222 can protrude from a side outer surface of the rotatable member 221b. The rotatable member 221b can be rotatably coupled to the fixing member 221a, so that the rotatable member 221b can rotate about an axis A1 with respect to the fixing member 221a. The axis A1 extends perpendicularly with respect to the assembling surface 211 and is commonly shared by the rotatable member 221b, the fixing member 221a, the tube opening 231, and the through hole 212.

FIG. 1D is a top view of the fluid supply assembly in FIG. 1C. Refer to FIGS. 1C and 1D, the rotatable member 221b in FIG. 1D is the rotatable member 221b in FIG. 1C after rotation, so the relative positions between the output members 222 in FIG. 1D differ from the relative positions between the output members 222 in FIG. 1C. The output heads 220 are isometrically arranged on the assembling surface 211. As shown in FIG. 1D, four axes A1 are actually located at four corners of a square. Moreover, when one rotatable member 221b of the output heads 220 rotates about one of the axes A1 with respect to the fixing member 221a, the rotatable members 221b respectively rotate along the axes A1 with respect to the fixing member 221a such that all output heads 220 are limited in a peripheral edge 211e of the assembling surface 211.

In the embodiment shown in FIG. 1D, the output member 222 physically interferes with the rotatable member 221b of another output head 220, which leads to the rotatable member 221b to rotate along the axis A1 with respect to the fixing member 221a. When the rotatable members 221b rotate about the respective axes A1 with respect to the fixing members 221a and all the rotatable members 221b respectively abut the rotatable members 221b, the output heads 220 are limited in the peripheral edge 211e of the assembling surface 211.

Notably, when all output heads 220 are limited in the peripheral edge 211e of the assembling surface 211, the output members 222 are not necessarily abutting the rotatable member 221b. Even one or more of the output members 222 do not abut the rotatable member 221b, the output heads 220 are limited within the peripheral edge 211e of the assembling surface 211. Thus, all output members 222 abutting the rotatable member 221b are not required to limit each output head 220 within the peripheral edge 211e.

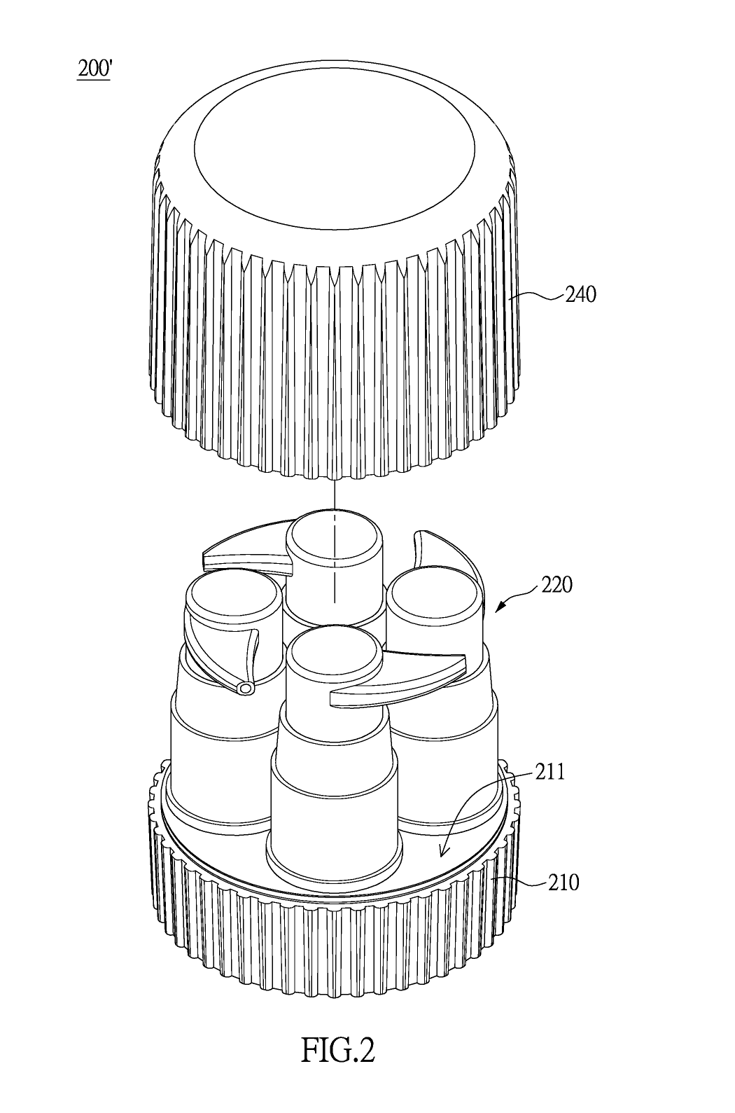

FIG. 2 is a perspective view of the fluid supply assembly in accordance with another embodiment of the instant disclosure. The fluid supply assembly 200′ and the aforementioned fluid supply assembly 200 differ in a cover body 240. The fluid supply assembly 200′ includes the fluid supply assembly 200 and the cover body 240. Since each output head 220 is limited within the peripheral edge 211e of the assembling surface 211, the cover body 240 is not affected by any interference from the output head 220 while still covering and protecting the output heads 220 and the assembling surface 211. Furthermore, the cover body 240 can be combined with the holding member 210. For example, the cover body 240 can be combined with the holding member 210 via transition fit, locking, or screwing.

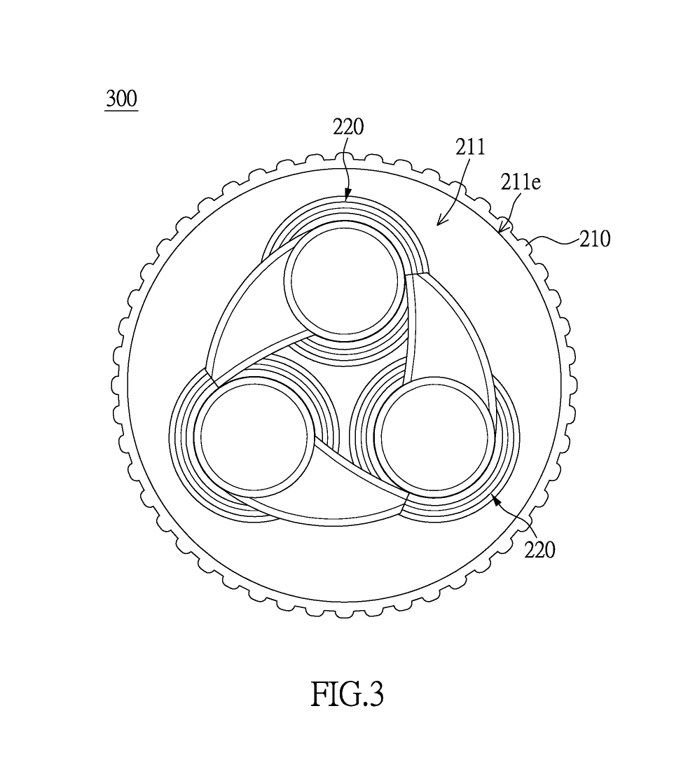

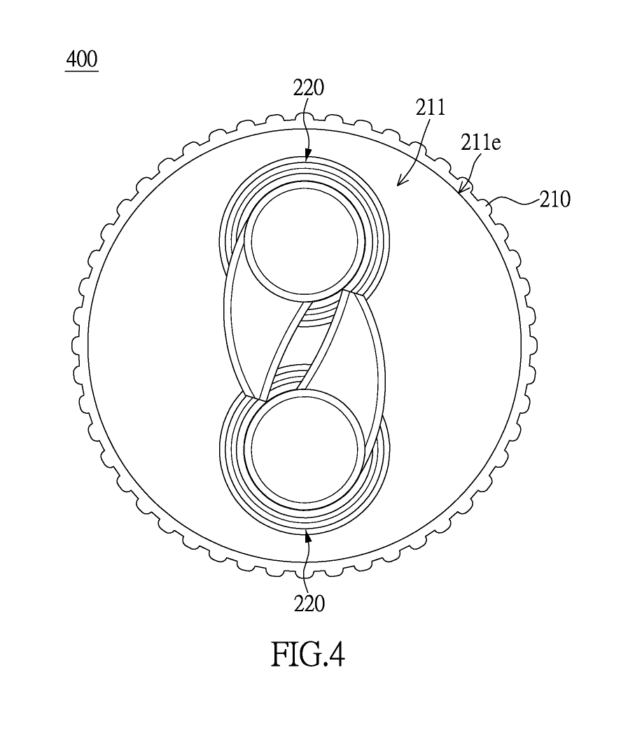

Notably, four output heads 220 are included in the aforementioned fluid supply assembly 200′ or 200. However, in another embodiment, the fluid supply assembly can include two, three, four, or even more output heads as shown in FIGS. 3 and 4.

Refer to FIGS. 3 and 4, the fluid supply assemblies 300, 400 in the two figures are similar to the fluid supply assembly 200 in the previous embodiment but differ in the number of output heads 220. Specifically, the fluid supply assembly 300 which includes three output heads 220 is isometrically fixed on the assembling surface 211, whereas the fluid supply assembly 400 in FIG. 4 includes two output heads 220 isometrically fixed on the assembling surface 211.

Furthermore, in the fluid supply assemblies 300, 400 shown in FIGS. 3 and 4, all output heads 220 are limited within the peripheral edge 211e of the assembling surface 211. The cover body 240 in FIG. 2 can also be applied on the fluid supply assemblies 300, 400. In other words, the cover body 240 can also cover the output heads 220 and the assembling surface 211 of either of the fluid supply assemblies 300, 400.

Notably, the output heads 220 are pump heads or dispensers in the previous embodiment. However, in another embodiment, the output heads 220 do not necessarily have to be pump dispensers. For example, the output heads 220 can be replaced by a lid from a soy sauce, vinegar or any type of condiment containing bottles. As such, the output heads 220 are not limited to be a pump dispenser. The supply container 100 is also not required to use a tube 130 to draw dish washing detergent, lotion, honey, maple syrup, soy sauce, or any type of fluids.

In summary, the chambers can accommodate at least two types of fluids (such as cleaning products and care products), and the fluid supply assembly provides users multiple fluids individually retained in one single supply container and a choice of a fluid retained in the one of the chambers. Compared to the existing individually packed bottles or cans of cleaning products and care products, the instant disclosure provides a single supply container that can be filled with multiple cleaning products or care products therein to reduce the spaced occupied, which is preferable for the generally small and tight city bathrooms.

In addition, since the instant disclosure provides a single supply container that can be filled with multiple cleaning products or care products therein, users who frequently travel or go on business trips can carry the single supply container as aforementioned, which retains a plurality of cleaning or care product fluids therein, without having to carry separate bottles or cans of cleaning or care products. The supply container in the instant embodiment provides convenience for users who often travel or go on business trips as a travel cleaning or care product kit.

Furthermore, the supply container in the instant embodiment can also be filled with a plurality of food products such as honey, maple syrup, ketchup, vinegar, sesame oil, soy sauce, etc. Compared to the bottles or cans of condiments, such as soy sauce, vinegar, or maple syrup, that are typically found in the kitchen or dinner table, the instant disclosure provides a supply container that replaces the bottles and cans of condiments, thus reducing the volume occupied in the kitchen as well as on dining table. Moreover, the supply container can also retain a plurality of food product fluids as a convenient condiment bottle that is travel compatible.

The figures and descriptions supra set forth illustrated the preferred embodiments of the instant disclosure; however, the characteristics of the instant disclosure are by no means restricted thereto. All changes, alternations, combinations or modifications conveniently considered by those skilled in the art are deemed to be encompassed within the scope of the instant disclosure delineated by the following claims.

What is claimed is:

1. A fluid supply assembly, comprising:
a holding member having an assembling surface, an outer surface opposite the assembling surface, and a plurality of through holes; wherein the through holes extend from the assembling surface to the outer surface; and
a plurality of output heads, each output head respectively fixed in one through hole, the output heads protruded from the assembling surface, each output head having an output opening; wherein each of the output heads respectively covers one through hole, and a fluid passing through one through hole and successively through one output opening.

2. The fluid supply assembly as recited in claim 1, further comprising:
a plurality of threaded tubes coupled to the holding member and fixed on the assembling surface; wherein each threaded tube has a tube opening, each threaded tube protrudes from the assembling surface, each tube opening is in fluid communication with one through hole, and each output head is securely coupled to one threaded tube.

3. The fluid supply assembly as recited in claim 1, wherein each output head comprising:
a fixing member disposed on the assembling surface;
a rotatable member rotatably coupled to the fixing member; wherein the rotatable member, the fixing member, and the through holes are aligned along a common axis, and the rotatable member rotates about the axis with respect to the fixing member; and
an output member having an output opening, the output member coupled to the rotatable member; wherein the output member protrudes from a side outer surface of the rotatable member, the rotatable members respectively rotate about the axes with respect to the fixing members, such that the output heads rotate within a peripheral edge of the assembling surface.

4. The fluid supply assembly as recited in claim 3, wherein the rotatable members respectively rotate about the axes with respect to the fixing members, such that the output members abut the rotatable members, and when the output members abut the rotatable members, the output heads rotate within the peripheral edge of the assembling surface.

5. The fluid supply assembly as recited in claim 1, further wherein the output head comprising:
a cover body covering the output heads and the assembling surface.

6. The fluid supply assembly as recited in claim 1, wherein the output head is a pump dispenser.

7. The fluid supply assembly as recited in claim 1, wherein the output heads are isometrically arranged on the assembling surface.

8. The fluid supply assembly as recited in claim 1, wherein a top end of one output head has a different color from a top end of another output head.

9. The fluid supply assembly as recited in claim 1, wherein the number of output heads is two or more.

10. A supply container, comprising:
a container body;
a divider arranged in the container body to form a plurality of chambers therein; and
a fluid supply assembly, comprising:
a holding member having an assembling surface, an outer surface opposite the assembling surface, and a plurality of through holes; wherein the through holes extend from the assembling surface to the outer surface; and
a plurality of output heads, each output head fixed in one of the through holes, the output heads protruded from the assembling surface, each output head having an output opening; wherein each output head covers one of the through holes, the holding member is arranged between the output heads and the container body, and each output opening is in fluid communication with one chamber via the respective through hole in a one-to-one configuration.

11. The fluid supply assembly as recited in claim 10, further comprising:
a plurality of tubes, each tube coupled to one output head, each tube respectively arranged through one through hole and arranged in one chamber in a one-to-one configuration; wherein each tube is in fluid communication with one output opening.

12. The fluid supply assembly as recited in claim 10, wherein the fluid supply assembly further comprising:
a plurality of threaded tubes coupled to the holding member and fixed on the assembling surface; wherein each threaded tube has a tube opening, each threaded tube protrudes from the assembling surface, each tube opening is in fluid communication with one through hole, and each output head is securely coupled to one threaded tube.

13. The fluid supply assembly as recited in claim 10, wherein the output head comprising:
a fixing member disposed on the assembling surface;
a rotatable member rotatably coupled to the fixing member;
wherein the rotatable member, the fixing member, and the through holes are aligned along a common axis, and the rotatable member rotates about the axis with respect to the fixing member; and
an output member having an output opening, the output member coupled to the rotatable member; wherein the output member protrudes from a side outer surface of the rotatable member, the rotatable members respectively rotate about the axes with respect to the fixing members, such that the output heads rotate within a peripheral edge of the assembling surface.

14. The fluid supply assembly as recited in claim 13, wherein the rotatable members respectively rotate about the axes with respect to the fixing members, such that the output members abut the rotatable members, and when the output members abut the rotatable members, the output heads rotate within the peripheral edge of the assembling surface.

15. The fluid supply assembly as recited in claim 10, wherein the fluid supply assembly further comprising:
a cover body covering the output heads and the assembling surface.

16. The fluid supply assembly as recited in claim 10, wherein the output head is a pump dispenser.

17. The fluid supply assembly as recited in claim 10, wherein the output heads are isometrically arranged on the assembling surface.

18. The fluid supply assembly as recited in claim 10, wherein a top end of one output head has a different color from a top end of another output head.
